(19) United States
(12) Patent Application Publication
(10) Pub. No.: US 2011/0261750 A1
(43) Pub. Date: Oct. 27, 2011

(54) RADIO TERMINAL, RELAY DEVICE, AND RADIO COMMUNICATION METHOD

(75) Inventors: Kyoko Fujito, Yokohama-shi (JP); Hirokazu Matsunami, Yokohama-shi (JP); Keiji Murakami, Yokohama-shi (JP)

(73) Assignee: KYOCERA CORPORATION, Kyoto-shi (JP)

(21) Appl. No.: 13/142,120

(22) PCT Filed: Dec. 24, 2009
(86) PCT No.: PCT/JP2009/071465

§ 371 Date: Jun. 24, 2011

(30) Foreign Application Priority Data
Dec. 25, 2008 (JP) 2008-331608
Dec. 25, 2008 (JP) 2008-331609

(51) Int. Cl. H04W 36/30; H04W 88/04; H04W 24/02

(52) U.S. Cl. 370/315

(57) ABSTRACT

Disclosed is a radio terminal that sets a communication path that transits a radio base station and a communication path that transits a radio base station, through an access gateway that is positioned upon a backhaul network, the radio terminal including a transmitter which transmits an uplink packet over the communication path to the access gateway, and transmits a dummy packet over the communication path to the access gateway, and a determination unit, which employs the uplink packet to determine a first communication quality of the communication path and employs the dummy packet to determine a second communication quality of the communication path wherein, when the second communication quality is higher than the first communication quality, the transmitter stops the transmission of the uplink packet over the communication path and transmits the uplink packet over the communication path.

### TECHNICAL FIELD

The present invention relates to a radio terminal configured to establish a first communication path via a first radio base station and a second communication path via a second radio base station to a relay device provided on a communication network, and relates to the relay device and a radio communication method.

### BACKGROUND ART

In a radio communication system, it is common that a same radio base station serves as a radio base station that performs radio communication with a radio terminal in an uplink in a direction from the radio terminal to a communication network and a radio base station that performs radio communication with the radio terminal in a downlink in a direction from the communication network to the radio terminal.

In recent years, provision of a radio communication system in which different radio base stations can serve as a radio base station that performs a radio communication with a radio terminal in an uplink (hereinafter referred to as a “first radio base station”) and a radio base station that performs a radio communication with the radio terminal in a downlink (hereinafter referred to as a “second radio base station”) has been studied in order to improve a degree of freedom for a radio terminal to select a radio base station (see Non-patent Document 1). Use of this radio communication system makes it possible to select a radio base station suitable for the first radio base station and a radio base station suitable for the second radio base station individually depending on radio qualities (such as RSSI, CINR, or the like) of radio links between the radio terminal and the radio base station, and thus to provide radio communication with a higher quality.

This radio communication system includes a relay device configured to perform communication with a radio terminal by use of two communication paths, namely, a first communication path established to the radio terminal via the first radio base station and a second communication path established to the radio terminal via the second radio base station when the first radio base station is different from the second radio base station. The relay device is provided on a communication network excluding the radio links.

### PRIOR ART DOCUMENTS

### Non-Patent Documents

Non-patent Document 1: “Overview for Ultra Mobile Broadband (UMB) Air Interface Specification (3GPP2 C. S0084-000-0)”, [online], [searched as of October 17, 2008], URL:http://www.3gpp2.org/Public_html/specs/C.S0084-000-0_v2.0_{—}070904.pdf

### SUMMARY OF THE INVENTION

However, in this radio communication system, numerous devices other than the radio base stations such as a router, a gateway, and the like are installed on a wired link between a relay device and a radio base station in each of the communication paths. For this reason, if any of the devices installed on a wired link has a failure such as a breakdown, the communication qualities of the entire first communication path used for uplink/downlink communication are degraded. That is, there is a problem that the uplink/downlink communication become difficult to continue.

Furthermore, if a delay or the like occurs due to an increase in traffic in the wired link between the first radio base station and the relay device, the communication qualities of the entire first communication path used for the uplink/downlink communication are degraded. In this case, real-time communications in uplink/downlink, in particular, have a problem of occurrence of a delay or a packet loss.

Accordingly, an objective of the present invention is to provide a radio terminal, a relay device, and a radio communication method that allow uplink/downlink communication to be performed favorably even when the communication qualities of a communication path used for the downlink/uplink communication are degraded in a radio communication system where different radio base stations can serve as a radio base station performing radio communication with a radio terminal in an uplink and a radio base station performing radio communication with the radio terminal in a downlink.

In order to solve the problems described above, the present invention has the following features. First of all, according to a first feature of the present invention, there is provided a radio terminal (radio terminal 2) configured to establish a first communication path (communication path 6) via a first radio base station (radio base station 1A) provided on a communication network (backhaul network 4) and a second communication path (communication path 7) via a second radio base station (radio base station 1B) provided on the communication network to a relay device (access gateway 3) provided on the communication network, the radio terminal comprising: a transmitter configured to transmit uplink data (uplink packet) to the relay device via the first communication path; a receiver configured to receive downlink data (downlink packet) from the relay device via the second communication path; and a determination unit configured to determine a first communication quality of the first communication path in an uplink and a second communication quality of the second communication path in the uplink, wherein the transmitter transmits predetermined data to be used to determine the second communication quality to the relay device via the second communication path, the determination unit determines the first communication quality by using the uplink data and determines the second communication quality by using the predetermined data, and the transmitter stops transmission of the uplink data via the first communication path and transmits the uplink data to the relay device via the second communication path when the second communication quality determined by the determination unit is higher than the first communication quality.

According to the above-described radio terminal, when the communication quality of the first communication path in the uplink is degraded below the communication quality of the second communication path in the uplink, it is possible to employ the second communication path as the communication path used for the communication in the uplink while stopping the first communication path. For this reason, it is possible to perform the uplink communication favorably even if the communication quality of the communication path used for the uplink communication is degraded.

A second feature of the present invention relates to the first feature of the present invention, and is summarized as follows. The transmitter transmits the uplink data with first transmission time information included therein to the relay device, the first transmission time information indicating a time at which the uplink data is transmitted, the receiver receives a first communication quality response including the first transmission time information and first reception time information indicating a time at which the uplink data is received by the relay device, the determination unit determines the first communication quality based on a difference between the first transmission time information and the first reception time information included in the first communication quality response, the transmitter transmits the predetermined data with second transmission time information included therein to the relay device, the second transmission time information indicating a time at which the predetermined data is transmitted, the receiver receives a second communication quality response including the second transmission time information and second reception time information indicating a time at which the predetermined data is received by the relay device, and the determination unit determines the second communication quality based on a difference between the second transmission time information and the second reception time information included in the second communication quality response.

A third feature of the present invention relates to the second feature of the present invention, and is summarized as follows. The transmitter transmits the uplink data in plurality and the predetermined data in plurality to the relay device, the receiver receives a plurality of first communication quality responses to the uplink data transmitted in plurality and a plurality of first communication quality responses to the predetermined data transmitted in plurality, the determination unit determines the first communication quality based on an average of differences between the first transmission time information and the first reception time information included in the plurality of first communication quality responses received by the receiver, and the determination unit determines the second communication quality based on an average of differences between the second transmission time information and the second reception time information included in the plurality of second communication quality responses received by the receiver.

A fourth feature of the present invention relates to the first feature of the present invention, and is summarized as follows. The transmitter transmits the uplink data in plurality and the predetermined data in plurality to the relay device, the receiver receives a first communication quality response including first initial reception time information indicating a reception time of the uplink data initially received by the relay device and first final reception time information indicating a reception time of the uplink data finally received by the relay device among the uplink data transmitted in plurality, and a second communication quality response including second initial reception time information indicating a reception time of the predetermined data initially received by the relay device and second final reception time information indicating a reception time of the predetermined data finally received by the relay device among the predetermined data transmitted in plurality, and the determination unit determines the first communication quality based on a difference between the first initial reception time information and the first final reception time information included in the first communication quality response, and the second communication quality based on a difference between the second initial reception time information and the second final reception time information included in the second communication quality response.

A fifth feature of the present invention relates to the fourth feature of the present invention, and is summarized as follows. The determination unit determines the first communication quality based on a total data amount of the uplink data transmitted in plurality by the transmitter and on the difference between the first initial reception time information and the first final reception time information included in the first communication quality response, and the second communication quality based on a total data amount of the predetermined data transmitted in plurality by the transmitter and on the difference between the second initial reception time information and the second final reception time information included in the second communication quality response.

A sixth feature of the present invention relates to the first feature of the present invention, and is summarized as follows. The transmitter transmits the predetermined data to the relay device when a radio quality between the radio terminal and the first radio base station is lower than a predetermined value.

A seventh feature of the present invention relates to the sixth feature of the present invention, and is summarized as follows. The transmitter transmits the predetermined data to the relay device when the number of bits per symbol is below a predetermined number in a modulation mode adapted to the radio quality.

According to an eighth feature of the present invention, there is provided a radio communication method in a radio terminal configured to establish a first communication path via a first radio base station provided on a communication network and a second communication path via a second radio base station provided on the communication network to a relay device provided on the communication network, the radio communication method comprising the steps of: transmitting uplink data to the relay device via the first communication path; receiving downlink data from the relay device via the second communication path; transmitting predetermined data to be used to determine a second communication quality of the second communication path in an uplink to the relay device via the second communication path; determining a first communication quality of the first communication path in the uplink by using the uplink data; determining the second communication quality by using the predetermined data; and stopping transmission of the uplink data via the first communication path and transmitting the uplink data to the relay device via the second communication path when the determined second communication quality is higher than the first communication quality.

According to a ninth feature of the present invention, there is provided a relay device (access gateway 3) provided on a communication network (backhaul network 4) and configured to establish a first communication path via a first radio base station (radio base station 1A) provided on the communication network and a second communication path via a second radio base station (radio base station 1B) provided on the communication network to a radio terminal (radio terminal 2), the relay device comprising: a receiver (receiver 1311) configured to receive uplink data from the radio terminal via the first communication path; a transmitter (transmitter 1312) configured to transmit downlink data to the radio terminal via the second communication path; and a determination unit (determination unit 1313) configured to determine a first communication quality of the first communication path in a downlink and a second communication quality of the second communication path in the downlink, wherein the transmitter transmits predetermined data (dummy packet) to be used to determine the first communication quality to the radio terminal via the first communication path, the determination unit determines the second communication quality by using the downlink data and determines the first communication quality by using the predetermined data, and the transmitter stops transmission of the downlink data via the second communication path and transmits the downlink data to the radio terminal via the first communication path when the first communication quality determined by the determination unit is higher than the second communication quality.

According to the above-described radio terminal, when the communication quality of the second communication path in the downlink is degraded below the communication quality of the first communication path in the downlink, it is possible to use the first communication path as the communication path used for the communication in the downlink while stopping the second communication path. For this reason, it is possible to perform the downlink communication favorably even if the communication quality of the communication path used for the downlink communication is degraded.

A tenth feature of the present invention relates to the ninth feature of the present invention, and is summarized as follows. The transmitter transmits the predetermined data with first transmission time information included therein to predetermined data, the first transmission time information indicating a time at which the predetermined data is transmitted the receiver receives a first communication quality response including the first transmission time information and first reception time information indicating a time at which the predetermined data is received by the radio terminal, the determination unit determines the first communication quality based on a difference between the first transmission time information and the first reception time information included in the first communication quality response, the transmitter transmits the downlink data with second transmission time information included therein to the radio terminal, the second transmission time information indicating a time at which the downlink data is transmitted, the receiver receives a second communication quality response including the second transmission time information and second reception time information indicating a time at which the downlink data is received by the radio terminal, and the determination unit determines the second communication quality based on a difference between the first transmission time information and the first reception time information included in the second communication quality response.

An eleventh feature of the present invention relates to the tenth feature of the present invention, and is summarized as follows. The transmitter transmits the predetermined data in plurality and the downlink data in plurality to the radio terminal, the receiver receives a plurality of first communication quality responses to the predetermined data transmitted in plurality and a plurality of second communication quality responses to the downlink data transmitted in plurality, the determination unit determines the first communication quality based on an average of differences between the first transmission time information and the first reception time information included in the plurality of first communication quality responses received by the receiver, and the determination unit determines the second communication quality based on an average of differences between the second transmission time information and the second reception time information included in the plurality of second communication quality responses received by the receiver.

A twelfth feature of the present invention relates to the ninth feature of the present invention, and is summarized as follows. The transmitter transmits the predetermined data in plurality and the downlink data in plurality to the radio terminal, the receiver receives a first communication quality response including first initial reception time information indicating a reception time of the predetermined data initially received by the radio terminal and first final reception time information indicating a reception time of the predetermined data finally received by the radio terminal among the predetermined data transmitted in plurality, and a second communication quality response including second initial reception time information indicating a reception time of the downlink data initially received by the radio terminal and second final reception time information indicating a reception time of the downlink data finally received by the radio terminal among the downlink data transmitted in plurality, and the determination unit determines the first communication quality based on a difference between the first initial reception time information and the first final reception time information included in the first communication quality response, and the second communication quality based on a difference between the second initial reception time information and the second final reception time information included in the second communication quality response.

A thirteenth feature of the present invention relates to the twelfth feature of the present invention, and is summarized as follows. The determination unit determines the first communication quality based on a total data amount of the predetermined data transmitted in plurality by the transmitter and on the difference between the first initial reception time information and the first final reception time information included in the first communication quality response, and the determination unit determines the second communication quality based on a total data amount of the downlink data transmitted in plurality by the transmitter and on the difference between the second initial reception time information and the second final reception time information included in the second communication quality response.

A fourteenth feature of the present invention relates to the ninth feature of the present invention, and is summarized as follows. The transmitter transmits the predetermined data to the radio terminal when a radio quality between the radio terminal and the second radio base station is lower than a predetermined value.

A fifteenth feature of the present invention relates to the fourteenth feature of the present invention, and is summarized as follows. The transmitter transmits the predetermined data to the radio terminal when the number of bits per symbol is below a predetermined number in a modulation mode adapted to the radio quality.

A sixteenth feature of the present invention relates to the ninth feature of the present invention, and is summarized as follows. The relay device further comprises: a path controller configured to establish a third communication path via the first radio base station to the radio terminal when the first communication quality determined by the determination unit is higher than the second communication quality, wherein the transmitter transmits the downlink data by using the third communication path instead of the first communication path when the third communication path is established, the first communication path is a communication path which is unusable for transmission of the downlink data, usable for transmission of the predetermined data, and unable to be established simultaneously with the third communication path, and the path controller releases establishment of the first communication path when establishing the third communication path.

According to a seventeenth feature of the present invention, there is provided a radio communication method in a relay device provided on a communication network and configured to establish a first communication path via a first radio base station provided on the communication network and a second communication path via a second radio base station provided on the communication network to a radio terminal, the radio communication method comprising the steps of: receiving predetermined data from the radio terminal via the first communication path; transmitting downlink data to the radio terminal via the second communication path; transmitting predetermined data to be used to determine a first communication quality of the first communication path in a downlink to the radio terminal via the first communication path; determining a second communication quality of the second communication path in the downlink by using the downlink data; determining the first communication quality by using the predetermined data; and stopping transmission of the downlink data via the second communication path and transmitting the downlink data to the radio terminal via the first communication path when the determined first communication quality is higher than the second communication quality.

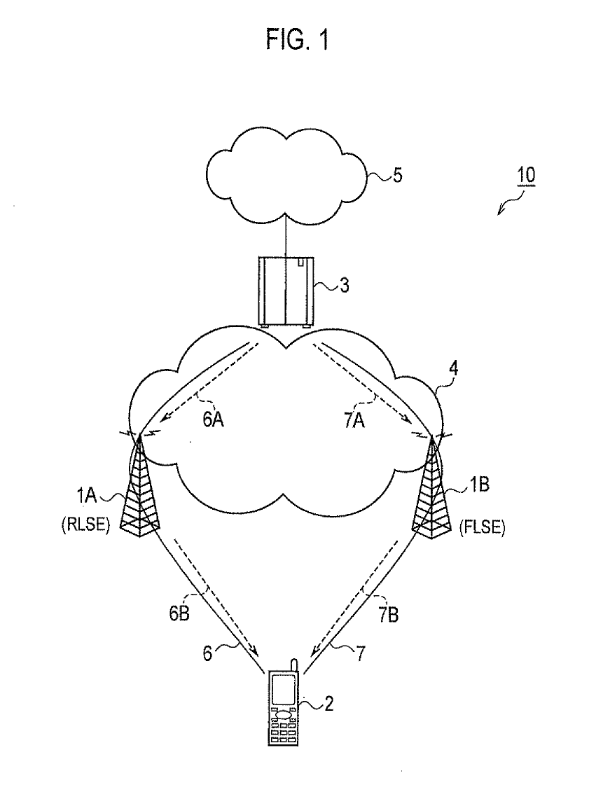

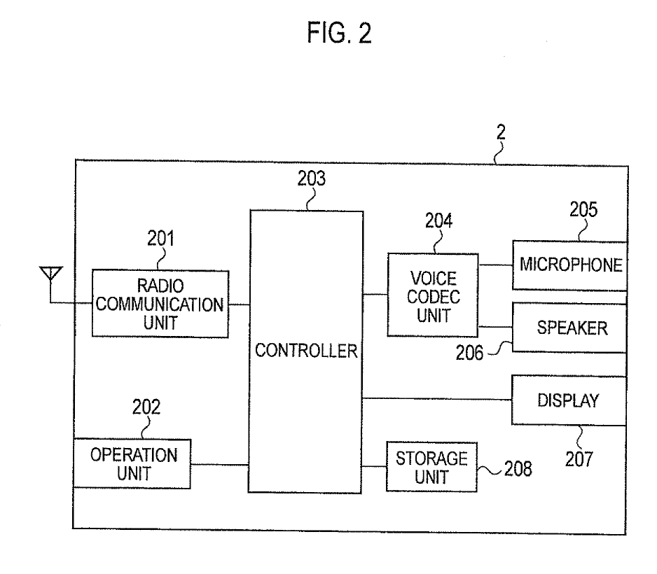

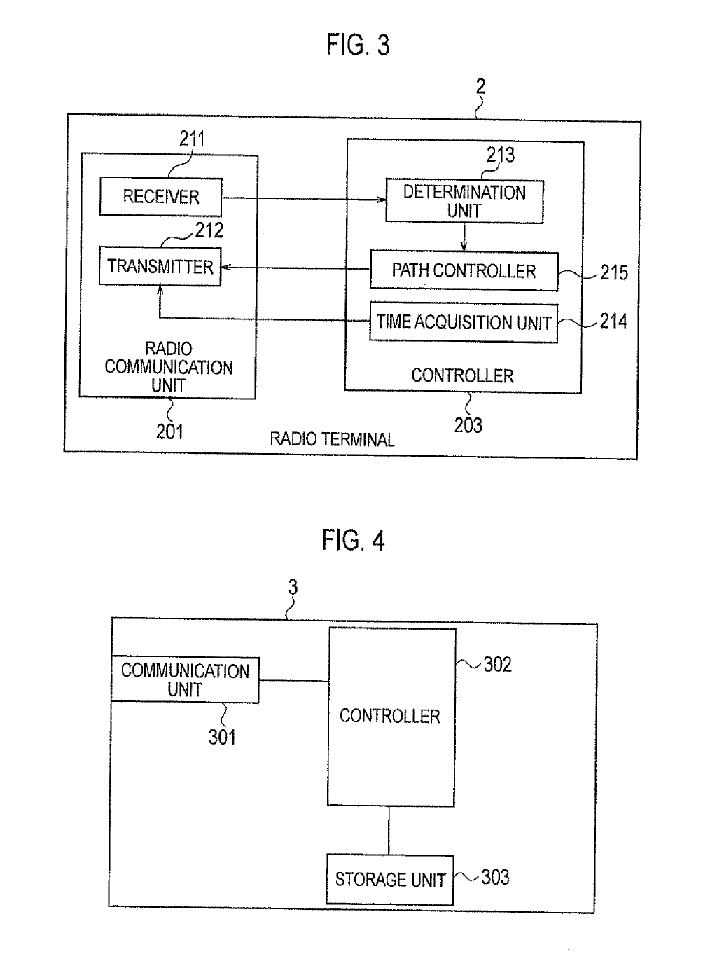

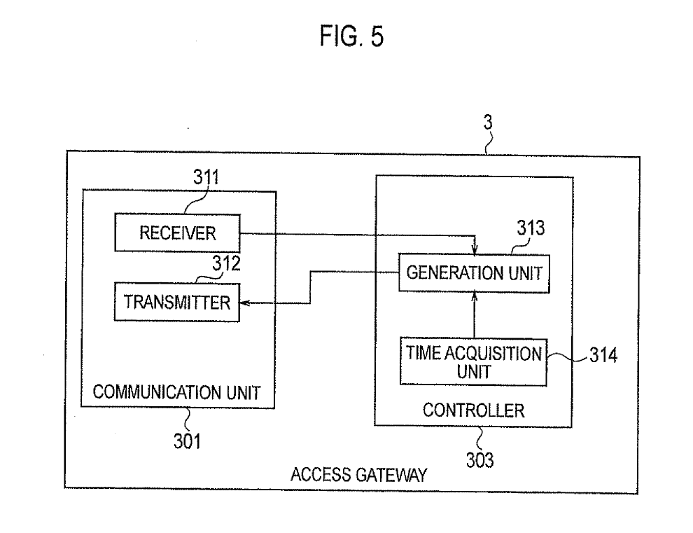

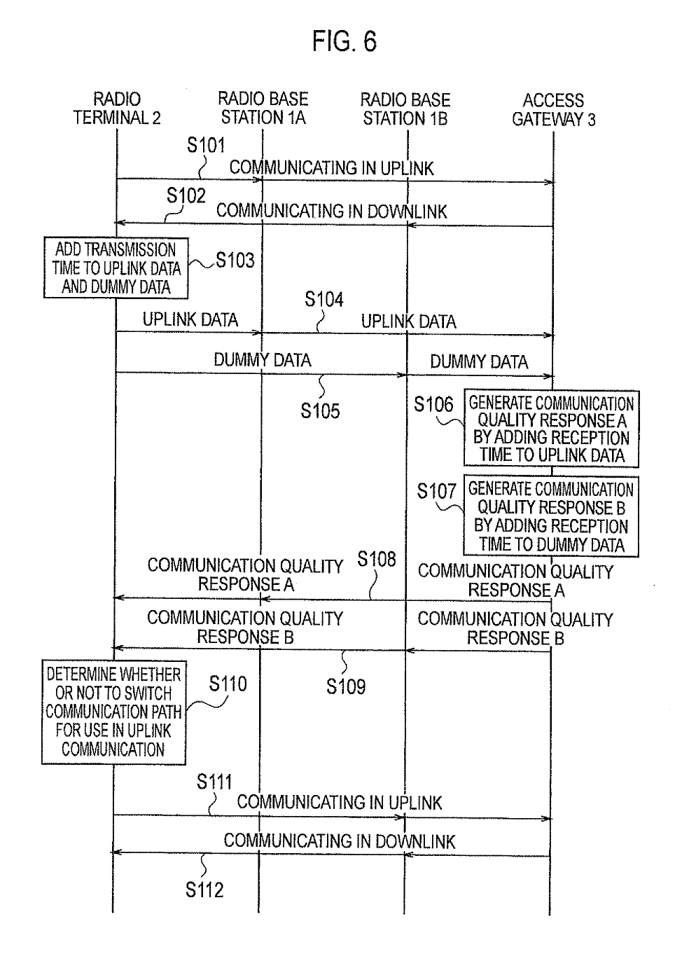

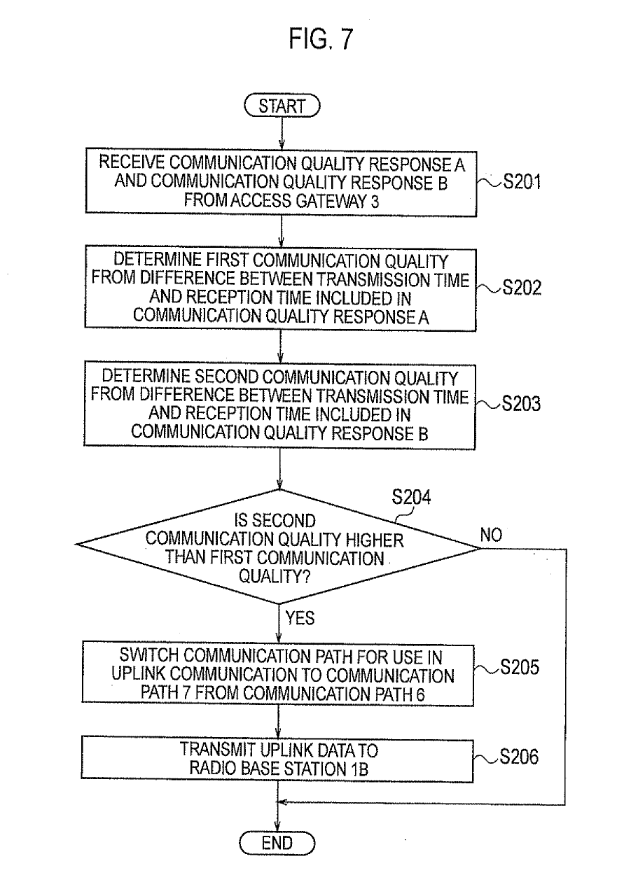

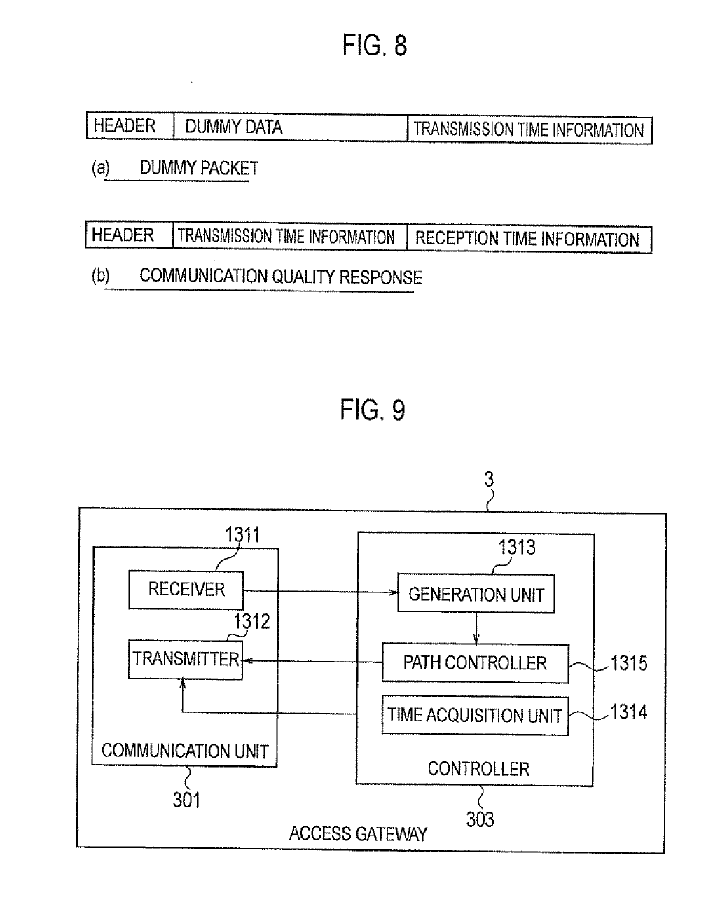

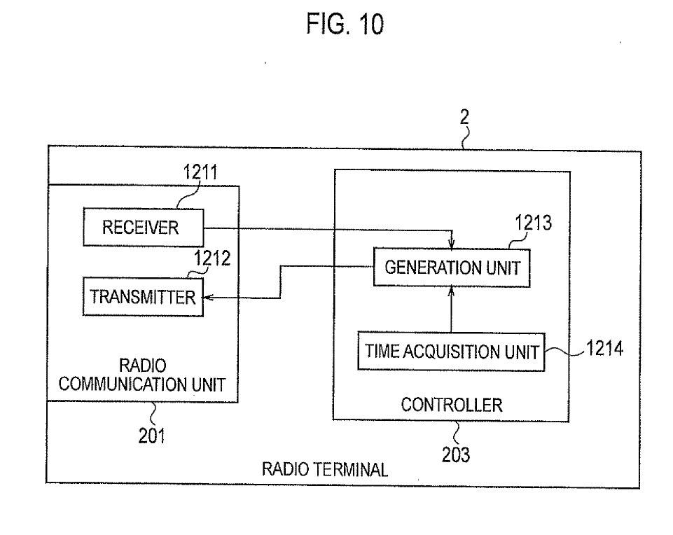

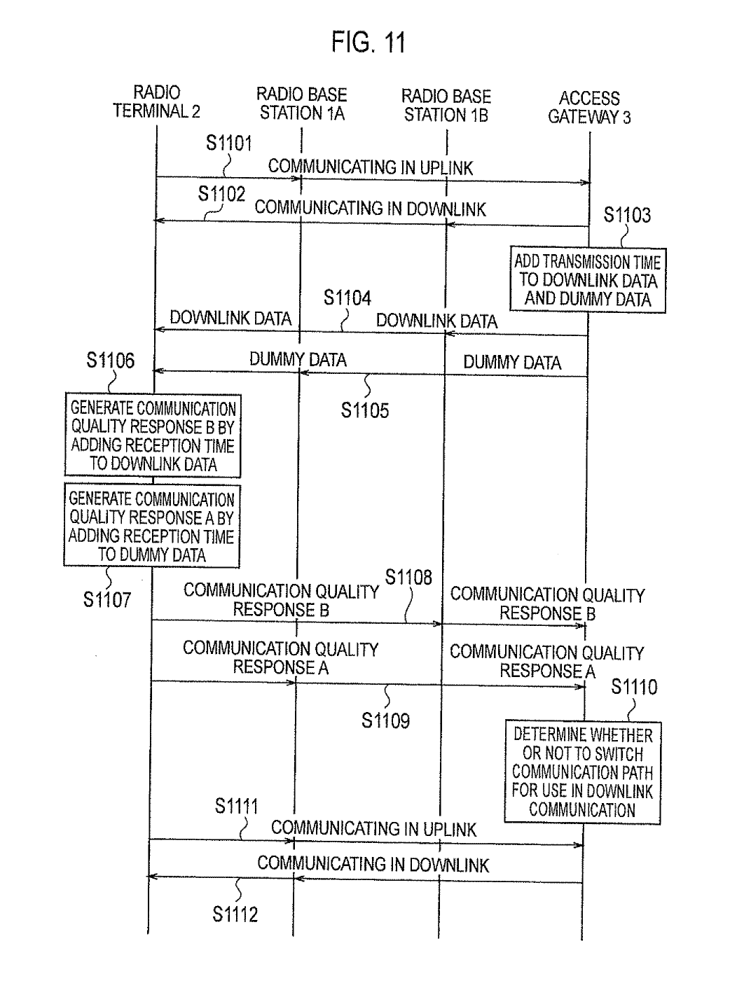

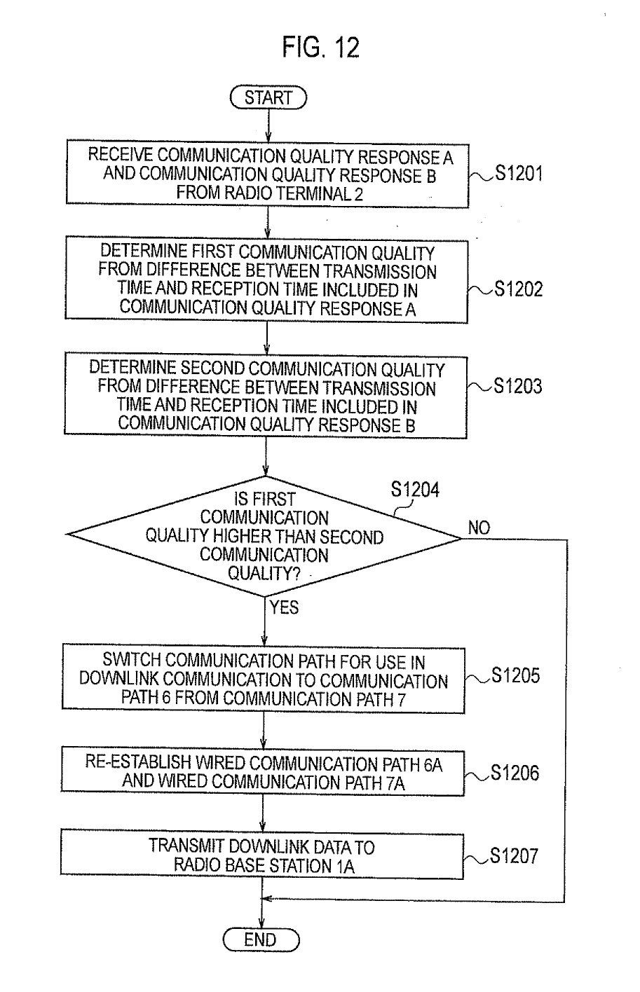

### BRIEF DESCRIPTION OF THE DRAWINGS

[FIG. 1] FIG. 1 is an overall schematic configuration diagram of a radio communication system according to a first embodiment and a second embodiment.

[FIG. 2] FIG. 2 is a schematic configuration diagram showing a schematic configuration of a radio terminal 2 according to the first embodiment and the second embodiment.

[FIG. 3] FIG. 3 is a functional block diagram showing the configuration of the radio terminal according to the first embodiment.

[FIG. 4] FIG. 4 is a schematic configuration diagram showing a schematic configuration of an access gateway 3 according to the first embodiment and the second embodiment.

[FIG. 5] FIG. 5 is a functional block diagram showing a configuration of the access gateway 3 according to the first embodiment.

[FIG. 6] FIG. 6 is a sequence diagram showing an operation to switch a communication path used for uplink communication according to the first embodiment.

[FIG. 7] FIG. 7 is a flowchart showing an operation performed by the radio terminal 2 according to the first embodiment to judge whether or not to switch the communication path used for the uplink communication.

[FIG. 8] FIG. 8 is a configuration diagram showing a configuration of a dummy packet according to the first embodiment and the second embodiment.

[FIG. 9] FIG. 9 is a functional block diagram showing the configuration of the access gateway 3 according to the second embodiment.

[FIG. 10] FIG. 10 is a functional block diagram showing the configuration of the radio terminal according to the second embodiment.

[FIG. 11] FIG. 11 is a sequence diagram showing an operation to switch a communication path used for downlink communication according to the second embodiment.

[FIG. 12] FIG. 12 is a flowchart showing an operation performed by the radio terminal 2 according to the second embodiment to judge whether or not it is appropriate to switch the communication path used for the downlink communication.

### DESCRIPTION OF EMBODIMENTS

A first embodiment and a second embodiment of the present invention are described below with reference to the drawings. Note that, in the following description of the drawings in the first embodiment and the second embodiment, same or similar reference signs denote same or similar elements and portions.

### First Embodiment

The first embodiment will be described below on (1) a configuration of a radio communication system, (2) an operation of the radio communication system, and (3) advantageous effects.

(1) Configuration of Radio Communication System

First, a configuration of a radio communication system according to the first embodiment of the present invention will be described in the order of (1.1) an overall schematic configuration of the radio communication system, (1.2) a configuration of a radio terminal, and (1.3) a configuration of an access gateway.

(1.1) Overall Schematic Configuration of Radio Communication System

FIG. 1 is an overall schematic configuration diagram of a radio communication system 10 according to the present invention. As shown in FIG. 1, the radio communication system 10 includes a radio base station 1A (a first radio base station), a radio base station 1B (a second radio base station), a radio terminal 2, an access gateway 3 (a relay device), a backhaul network 4 (a communication network), and a backbone network 5. In the first embodiment, the radio communication system 10 has the configuration based on 3GPP2 UMB Air Interface (hereinafter simply referred to as a “UMB system”), which is one of wide-area IP broadband systems.

The radio base station 1A, the radio base station 1B, and the access gateway 3 are installed in the backhaul network 4 and are in wired connection to one another via the backhaul network 4. The radio terminal 2 establishes with the access gateway 3 a communication path 6 that passes through the radio base station 1A and a communication path 7 that passes through the radio base station 1B.

The radio base station 1A and the radio base station 1B can communicate with the backbone network 5 via the access gateway 3. The backhaul network 4 is a wired network and numerous unillustrated devices including routers, gateways, and the like are installed therein. The backbone network 5 is a wide-area communication network such as the Internet and the access gateway 3 is a gateway device for the wide-area communication network.

In FIG. 1, the access gateway 3 establishes a wired communication path 6A (namely, an IP tunnel (RL Only Binding)) with the radio base station 1A and a wired communication path 7A (namely, an IP tunnel (Primary Binding)) with the radio base station 1B.

The radio base station 1A and the radio base station 1B perform radio communications with the radio terminal 2 located in a communication available area. The radio terminal 2 establishes a radio communication path 6B with the radio base station 1A and a radio communication path 7B with the radio base station 1B.

From now on, the communication path which is a combination of the wired communication path 6A and the radio communication path 6B will be referred to as a communication path 6 (a first communication path) and the communication path which is a combination of the wired communication path 7A and the radio communication path 7B will be referred to as a communication path 7 (a second communication path). Note that the communication path 6 passes through the radio base station 1A and the communication path 7 passes through the radio base station 1B. In FIG. 1, uplink communication takes place in the communication path 6 while downlink communication takes place in the communication path 7.

Specifically, in the uplink communication, an uplink packet is transmitted from the radio terminal 2 and arrives at the radio base station 1A via the radio communication path 6B. Then, the uplink packet is transmitted from the radio base station 1A to the access gateway 3 via the wired communication path 6A. Meanwhile, in the downlink communication, a downlink packet is transmitted from the access gateway 3 and arrives at the radio base station 1B via the wired communication path 7A. Then, the downlink packet is transmitted from the radio base station 1B to the radio terminal 2 via the radio communication path 7B.

In the UMB system, a radio base station such as the radio base station 1A which actually receives the uplink packet from the radio terminal 2 is called an RLSE (Reverse Link Serving eBS) and a radio base station such as the radio base station 1B which actually transmits the downlink packet to the radio terminal 2 is called as an FLSE (Forward Link Serving eBS).

In the first embodiment, the uplink communication is described below on the assumption that the radio base station 1A is the RLSE and that the radio base station 1B is the FLSE.

(1.2) Configuration of Radio Terminal

Next, a configuration of the radio terminal 2 will be described in the order of (1.2.1) a schematic configuration of the radio terminal and (1.2.2) a detailed configuration of the radio terminal.

(1.2.1) Schematic Configuration of Radio Terminal

FIG. 2 is a schematic configuration diagram showing a schematic configuration of the radio terminal 2.

As shown in FIG. 2, the radio terminal 2 includes a radio communication unit 201, an operation unit 202, a controller 203, a voice codec unit 204, a microphone 205, a speaker 206, a display 207, and a storage unit 208.

The radio communication unit 201 includes an LNA, a power amplifier, an up-converter, a down-converter, and the like and is configured to perform transmission and reception of radio signals. The controller 203 is formed of a CPU, for example, and is configured to control various functions provided in the radio terminal 2. Moreover, the controller 203 executes processing in accordance with various protocols to be described later. The storage unit 208 is formed of a memory, for example, and is configured to store a variety of information used for the control in the radio terminal 2, and the like.

The display 207 is configured to display an image received via the controller 203 and to display contents of an operation (inputted telephone numbers, addresses, and the like). The operation unit 202 includes numerical keys, function keys, and the like and is an interface used for inputting the contents of operation by a user.

The microphone 205 is configured to collect voices and to input voice data based on the collected voices to the controller 203 via the voice codec unit 204. The speaker 206 is configured to output the voices based on the voice data acquired from the controller 203 via the voice codec unit 204.

The voice codec unit 204 is formed in accordance with the voice codec mode G. 729, for example. G. 729 is the mode designed to perform sampling of signals in an analog telephone frequency band (3.4 kHz≈4 kHz) at 8 kHz to achieve a signal transmission rate of 8 kbps.

(1.2.2) Detailed Configuration of Radio Terminal

The detailed configuration of the radio terminal 2, or namely, functional blocks of the radio communication unit 201 and the controller 203 will be described. FIG. 3 is a functional block diagram of the radio communication unit 201 and the controller 203 in the first embodiment.

As shown in FIG. 3, the radio communication unit 201 includes a receiver 211 and a transmitter 212. The controller 203 includes a determination unit 213, a time acquisition unit 214, and a path controller 215.

The receiver 211 receives the downlink packet from the access gateway 3 via the communication path 7.

The transmitter 212 transmits the uplink packet to the access gateway 3 via the communication path 6. The transmitter 212 transmits a dummy packet (predetermined data) for measuring a communication quality of the communication path 7 to the access gateway 3 via the communication path 7.

Here, the transmitter 212 adds a time stamp indicating transmission time (hereinafter referred to as transmission time information) to the uplink packet and the dummy packet to be transmitted for the measurement of the communication quality. The transmitter 212 acquires current time periodically from the time acquisition unit 214. As shown in FIG. 8(a), the dummy packet includes a header field and a payload. The payload includes dummy data and the transmission time information. The dummy data may include information indicating that the data is used for measuring the communication quality of the communication path 7, information indicating that the data may be discarded, and the like.

The time acquisition unit 214 periodically transmits the current time to the transmitter 212.

The receiver 211 receives a communication quality response A for the uplink packet from the access gateway 3 via the communication path 6. The receiver 211 receives a communication quality response B for the dummy packet from the access gateway 3 via the communication path 7. Then, the communication quality response A and the communication quality response B thus received are transmitted to the determination unit 213.

Here, the communication quality response A and the communication quality response B have configurations as shown in FIG. 8(b). Specifically, the communication quality responses each includes the transmission time information included in the uplink packet and the dummy packet, and a time stamp indicating reception time representing time at which the access gateway 3 receives the uplink packet and the dummy packet (hereinafter referred to as reception time information).

The determination unit 213 determines a first communication quality representing the communication quality of the communication path 6 and a second communication quality representing the communication quality of the communication path 7 from the communication quality response A and the communication response B received from the receiver 211. Specifically, the communication quality is throughput, a transmission delay or the like in the communication path. In the first embodiment, the transmission delay is used as the communication quality.

In the first embodiment, the first communication quality and the second communication quality are obtained by calculating a difference between the transmission time and the reception time by use of the transmission time and the reception time (see FIG. 8(b)) included in each of the communication quality response A and the communication quality response B. A large difference corresponds to a low value while a small difference corresponds to a high value.

The path controller 215 compares the first communication quality and the second communication quality determined by the determination unit 213. The use of the communication path 6 as the communication path for the uplink communication is continued when the result of the comparison indicates that the second communication quality is equal to or below the first communication quality. On the other hand, the communication path used for the uplink communication is switched to the communication path 7 when the result of the comparison indicates that the second communication quality is higher than the first communication quality. Moreover, when the communication path used for the uplink communication is switched to the communication path 7, the path controller 215 does not release the communication path 6 but retains the communication path 6 so as to be usable for the uplink communication any time.

(1.3) Configuration of Access Gateway

Next, a configuration of the access gateway 3 will be described in the order of (1.3.1) a schematic configuration of the access gateway and (1.3.2) a detailed configuration of the access gateway.

(1.3.1) Schematic Configuration of Access Gateway

FIG. 4 is a schematic configuration diagram showing a schematic configuration of the access gateway 3.

As shown in FIG. 4, the access gateway 3 includes a communication unit 301, a controller 302, and a storage unit 303.

The communication unit 301 is in wired connection with the radio base station 1A, the radio base station 1B, and the like via the backhaul network 4. Moreover, the communication unit 301 is in wired connection with the backbone network 5 as well. The controller 302 is formed of a CPU, for example, and is configured to control various functions provided in the access gateway 3. The storage unit 303 is formed of a memory, for example, and is configured to store a variety of information used for the control in the access gateway 3, and the like.

(1.3.2) Detailed Configuration of Access Gateway

The detailed configuration of the access gateway 3, or namely, functional blocks of the communication unit 301 and the controller 302 will be described. FIG. 5 is a functional block diagram of the communication unit 301 and the controller 302.

As shown in FIG. 5, the communication unit 301 includes a receiver 311 and a transmitter 312. The controller 302 includes a generation unit 313 and a time acquisition unit 314.

The receiver 311 receives the uplink packet from the radio terminal 2 via the communication path 6. The receiver 311 receives the dummy packet from the radio terminal 2 via the communication path 7. The receiver 311 transmits the uplink packet and the dummy packet to the generation unit 313.

The generation unit 313 generates the communication quality response A and the communication quality response B from the uplink packet and the dummy packet received from the receiver 311. Specifically, the generation unit 313 generates the communication quality response A by adding the reception time acquired from the time acquisition unit 314 to the received uplink packet. Similarly, the generation unit 313 generates the communication quality response B by adding the reception time acquired from the time acquisition unit 314 to the received dummy packet.

The generation unit 313 transmits the communication quality response A and the communication quality response B thus generated to the transmitter. The transmitter 312 transmits the communication quality response A to the radio terminal 2 via the communication path 6. The transmitter 312 transmits the communication quality response B to the radio terminal 2 via the communication path 7. The time acquisition unit 314 transmits the current time to the generation unit 313 periodically.

(2) Operation of Radio Communication System

Now, (2.1) an overall operation of the radio communication system, and (2.2) a judgment operation for communication path switching in the radio terminal will be described below in this order.

(2.1) Overall Operation of Radio Communication System

FIG. 6 is a sequence diagram showing an operation performed when the radio terminal 2 switches the communication path used for the uplink communication from the communication path 6 to the communication path 7. Note that this operation is started with at least any one of (a) to (c) indicated below as a trigger.

(a) The operation starts at every predetermined intervals.

(b) The operation starts when a radio quality (such as RSSI, SNR, or the like) of the radio communication path 6B is degraded.

(c) The operation starts when the number of bits per symbol is below a predetermined number in a modulation mode adapted to the radio quality of the radio communication path 6B.

In Step S101, the radio terminal 2 and the access gateway 3 are performing the uplink communication by using the communication path 6. Specifically, the transmitter 212 of the radio terminal 2 is transmitting the uplink packet to the access gateway 3 via the radio base station 1A.

In Step S102, the radio terminal 2 and the access gateway 3 are performing the downlink communication by using the communication path 7. Specifically, the transmitter 312 of the access gateway 3 is transmitting the downlink packet to the radio terminal 2 via the radio base station 1B.

In Step S103, the transmitter 212 of the radio terminal 2 adds the transmission time information to the uplink packet and the dummy packet, which indicates the time at which each of the packets is transmitted. In Step S104, the transmitter 212 of the radio terminal 2 transmits the uplink packet to the access gateway 3 via the communication path 6. In Step S105, the transmitter 212 of the radio terminal 2 transmits the dummy packet to the access gateway 3 via the communication path 7.

In Step S106, the generation unit 313 of the access gateway 3 generates the communication quality response A by adding the reception time of the uplink packet. In Step S107, the generation unit 313 of the access gateway 3 generates the communication quality response B by adding the reception time of the dummy packet is added.

In Step S108, the transmitter 312 of the access gateway 3 transmits the generated communication quality response A to the radio terminal 2 via the communication path 6. In Step S109, the access gateway 3 after the generation transmits the communication quality response B to the radio terminal 2 via the communication path 7.

In Step S110, the radio terminal 2 judges whether or not to switch the communication path used for the uplink communication. The concrete judgment operation will be described in (2.2) a judgment operation for communication path switching in the radio terminal. Here, the description will continue on the assumption that the second communication quality is higher than the first communication quality (YES in Step S204 in FIG. 7).

In Step S111, the radio terminal 2 and the access gateway 3 are performing the uplink communication by using the communication path 7. Specifically, the transmitter 212 of the radio terminal 2 is transmitting the uplink packet to the access gateway 3 via the radio base station 1B.

In Step S112, the radio terminal 2 and the access gateway 3 are performing the downlink communication by using the communication path 7. Specifically, the transmitter 312 of the access gateway 3 is transmitting the downlink packet to the radio terminal 2 via the radio base station 1B. That is, the communications in two directions, specifically, the uplink communication and the downlink communication, are carried out by using the communication path 7. Accordingly, the radio base station 1B has functions as both RLSE and FLSE.

(2.2) Judgment Operation for Communication Path Switching in Radio Terminal

FIG. 7 is a flowchart showing an operation performed by the radio terminal 2 to judge whether or not to switch the communication path used for the uplink communication.

In Step S201, the receiver 211 of the radio terminal 2 receives the communication quality response A and the communication quality response B from the access gateway 3. In Step S202, the determination unit 213 of the radio terminal 2 determines the first communication quality by use of the difference between the transmission time and the reception time included in the communication quality response A. Specifically, in this embodiment, the first communication quality is based on arrival time consumed from the transmission to the reception. For example, if the arrival time is long, it is likely that the quality of the communication path is degraded and the first communication quality is low. On the other hand, if the arrival time is short, it is likely that that the quality of the communication path is fine and the first communication quality is high.

In Step S203, the determination unit 213 of the radio terminal 2 determines the second communication quality by use of the difference between the transmission time and the reception time included in the communication quality response B. Similarly to the first communication quality, the second communication quality is based on the arrival time consumed from the transmission to the reception.

Instep S204, the determination unit 213 of the radio terminal 2 judges whether or not the second communication quality is higher than the first communication quality.

If the second communication quality is higher than the first communication quality (YES in Step S204), the path controller 215 of the radio terminal 2 switches the communication path used for the uplink communication from the communication path 6 having the low communication quality to the communication path 7 having the high communication quality in Step S205. Specifically, the path controller 215 determines to stop the transmission of the uplink packet to the access gateway 3 via the communication path 6 and determines to transmit the uplink packet to the access gateway 3 via the communication path 7.

In Step S206, the transmitter 212 of the radio terminal 2 transmits the uplink packet to the access gateway 3 via the communication path 7. Specifically, the transmitter 212 transmits the uplink packet to the access gateway 3 via the communication path 7 having the higher communication quality than the communication path 6.

When the second communication quality is equal to or below the first communication quality (NO in Step S204), the communication is continued without change. Specifically, the use of the communication path 6 having the high communication quality as the communication path used for the uplink communication is continued without switching to the communication path 7 having the low communication quality.

(3) Advantageous Effects

As described above, according to the first embodiment, the transmitter 212 stops the transmission of the uplink packet via the communication path 6 and transmits the uplink packet via the communication path 7 when the second communication quality determined by the determination unit 213 is higher than the first communication quality.

According to the above-described radio terminal 2, when the communication quality of the communication path 6 in the uplink is degraded below the communication quality of the communication path 7 in the uplink, it is possible to stop the communication path 6 and to use the communication path 7 as the communication path used for the uplink communication. For this reason, even when the communication quality of the communication path used for the uplink communication is degraded, it is possible to perform the uplink communication favorably.

Furthermore, the determination unit 213 determines the first communication quality based on the difference between the transmission time information and the reception time information included in the communication quality response A, and determines the second communication quality based on the difference between the transmission time information and the reception time information included in the communication quality response B.

According to the above-described radio terminal 2, it is possible to measure arrival time from the radio terminal 2 to the access gateway 3 on the communication path 6 (throughput of the communication path 6) by use of the uplink packet. Moreover, it is possible to measure arrival time from the radio terminal 2 to the access gateway 3 on the communication path 7 (throughput of the communication path 7) by use of the dummy packet.

For this reason, since the communication qualities of the communication path 6 and the communication path 7 can be determined based on the arrival time of the uplink packet and the dummy packet, it is possible to use one of the communication path 6 and the communication path 7 having the better throughput for the uplink communication. Specifically, even if the throughput of the communication path 6 is degraded by an increase in the traffic on the communication path 6, it is possible to switch the communication path for the uplink to the communication path 7 which is the known communication path. Hence it is possible to perform the uplink communication with a real-time performance.

Furthermore, the transmitter 212 transmits the dummy packet to the access gateway 3 when the radio quality between the radio terminal 2 and the radio base station 1A is lower than a predetermined value. Alternatively, the transmitter 212 transmits the dummy packet to the access gateway 3 when the number of bits per symbol is below a predetermined number in the modulation mode adapted to the radio quality between the radio terminal 2 and the radio base station 1A.

Specifically, the transmitter 212 does not transmit the dummy packet to the access gateway 3 when the radio quality between the radio terminal 2 and the radio base station 1A is equal to or above the predetermined value. The transmitter 212 does not transmit the dummy packet to the access gateway 3 when the number of bits per symbol is equal to or above the predetermined number in the modulation mode adapted to the radio quality between the radio terminal 2 and the radio base station 1A.

That is, the judgment operation for communication path switching is started only when the radio quality of the radio section is degraded. Accordingly, it is possible reduce a frequency of transmission of the dummy packet.

### Modification of First Embodiment

In the above-described first embodiment, the determination unit 213 determines the first communication quality and the second communication quality based on the differences between the transmission time information and the reception time information included in the communication quality response A and the communication quality response B.

In a modification of the first embodiment, the determination unit 213 determines the first communication quality and the second communication quality by using at least one of methods using (1) average arrival time, (2) reception time interval, and (3) reception time interval and data amount.

(1) Average Arrival Time

The transmitter 212 of the radio terminal 2 prepares multiple sets of the uplink packets and the dummy packets for determining the communication qualities of the communication path 6 and the communication path 7. For example, N pieces of the uplink packets and N pieces of the dummy packets are prepared and defined as the uplink packet 1 to the uplink packet N and as the dummy packet 1 to the dummy packet N. The transmitter 212 of the radio terminal 2 adds the transmission time information to each of the multiple uplink packets (the uplink packet 1 to the uplink packet N) and the multiple dummy packets (the dummy packet 1 to the dummy packet N). Then, the transmitter 212 of the radio terminal 2 transmits the multiple uplink packets to the access gateway 3 via the communication path 6. The transmitter 212 of the radio station 2 transmits the multiple dummy packets to the access gateway 3 via the communication path 7.

The generation unit 313 of the access gateway 3 generates the multiple communication quality responses A (the communication quality response Al to the communication quality response AN) by adding the reception times of the respective multiple uplink packets. The generation unit 313 of the access gateway 3 generates the multiple communication quality responses B (the communication quality response B1 to the communication quality response BN) by adding the reception times of the respective multiple dummy packets.

The transmitter 312 of the access gateway 3 transmits the multiple communication quality responses A thus generated to the radio terminal 2 via the communication path 7. The transmitter 312 of the access gateway 3 transmits the multiple communication quality responses B to the radio terminal 2 via the communication path 7.

The receiver 211 of the radio terminal 2 receives the multiple communication quality responses A and the multiple communication quality responses B from the access gateway 3. The determination unit 213 of the radio terminal 2 obtains the difference between the transmission time and the reception time included in each of the multiple communication quality responses A, and obtains a first average difference which is an average value of the multiple differences thus obtained. Thereafter, the determination unit 213 of the radio terminal 2 determines the first communication quality by use of the first average difference.

Similarly, the determination unit 213 of the radio terminal 2 obtains the difference between the transmission time and the reception time included in each of the multiple communication quality responses B, and obtains a second average difference which is an average value of the multiple differences thus obtained. Thereafter, the determination unit 213 of the radio terminal 2 determines the second communication quality by use of the second average difference.

Alternatively, it is also possible to obtain the differences between the transmission time and the reception time only for any number of responses among the multiple communication quality responses A and the multiple communication quality responses B, and to determine the first communication quality and the second communication quality by use of average values of the differences obtained for the any number of responses.

(1) Reception Time Interval

The transmitter 212 of the radio terminal 2 prepares multiple sets of the uplink packets and the dummy packets for determining the communication qualities of the communication path 6 and the communication path 7. For example, N pieces of the uplink packets and N pieces of the dummy packets are prepared and defined as the uplink packet 1 to the uplink packet N and as the dummy packet 1 to the dummy packet N. Then, the transmitter 212 of the radio station 2 transmits the multiple uplink packets to the access gateway 3 via the communication path 6. The transmitter 212 of the radio station 2 transmits the multiple dummy packets to the access gateway 3 via the communication path 7.

The generation unit 313 of the access gateway 3 generates the communication quality response A which includes initial reception time being the reception time of the downlink packet initially received among the multiple downlink packets and final reception time being the reception time of the downlink packet finally received among the multiple downlink packets. The generation unit 313 of the access gateway 3 generates the communication quality response B which includes initial reception time being the reception time of the dummy packet initially received among the multiple dummy packets and final reception time being the reception time of the dummy packet finally received among the multiple dummy packets.

The transmitter 312 of the access gateway 3 transmits the communication quality response A thus generated to the radio terminal 2 via the communication path 7. The transmitter 312 of the access gateway 3 transmits the communication quality response B to the radio terminal 2 via the communication path 7.

The receiver 211 of the radio terminal 2 receives the communication quality response A and the communication quality response B from the access gateway 3. The determination unit 213 of the radio terminal 2 determines the first communication quality from the difference between the initial reception time and the final reception time included in the communication quality response A and determines the second communication quality from the difference between the initial reception time and the final reception time included in the communication quality response B.

(3) Reception Time Interval and Data Amount

In the case of (2), the determination unit 213 of the radio terminal 2 determines the first communication quality based on a data size which is a sum of data amounts of the multiple uplink packets transmitted from the transmitter 212 of the radio base terminal 2, and on a difference between initial reception time information and final reception time information included in the communication quality response A.

Similarly, the determination unit 213 of the radio terminal 2 determines the second communication quality based on a data size which is a sum of data amounts of the multiple dummy packets transmitted from the transmitter 212 of the radio base terminal 2, and on a difference between initial reception time information and final reception time information included in the communication quality response B.

(4) Advantageous Effects of Modification of First Embodiment

As described above, the communication quality can be more accurately determined by determining the communication quality of the communication path by use of the multiple pieces of data. Therefore, the communication path having the fine communication quality can be used accurately for the uplink communication and the uplink communication can be favorably performed.

### Second Embodiment

While the above-described first embodiment explains the uplink communication, a second embodiment described below explains the downlink communication. It is to be noted that different points from those in the first embodiment will be described in the second embodiment and duplicate explanation will be omitted.

The second embodiment will be described below on (1) a configuration of a radio communication system, (2) an operation of the radio communication system, and (3) advantageous effects.

(1) Configuration of Radio Communication System

A configuration of a radio communication system according to the second embodiment of the present invention will be described below in the order of (1.1) a configuration of an access gateway and (1.2) a configuration of a radio terminal.

(1.1) Configuration of Access Gateway

A detailed configuration of the access gateway 3 according to the second embodiment, specifically, functional blocks of the communication unit 301 and the controller 302 are described. FIG. 9 is a functional block diagram of the communication unit 301 and the controller 302 according to the second embodiment.

As shown in FIG. 9, the communication unit 301 includes a receiver 1311 and a transmitter 1312. The controller 302 includes a determination unit 1313, a time acquiring unit 1314, and a path controller 1316.

The receiver 1311 receives the uplink packet from the radio terminal 2 via the communication path 6.

The transmitter 1312 transmits the downlink packet to the radio terminal 2 via the communication path 7. The transmitter 1312 transmits a dummy packet (predetermined data) for measuring a communication quality of the communication path 6 to the radio terminal 2 via the communication path 6.

Here, the transmitter 1312 adds a time stamp indicating transmission time (hereinafter referred to as transmission time information) to the downlink packet to be transmitted for the measurement of the communication quality. The transmitter 1312 acquires current time periodically from the time acquisition unit 1314. The dummy packet has a configuration similar as that in the first embodiment (see FIG. 8(a)).

The receiver 1311 receives the communication quality response B (second communication quality) for the downlink packet from the radio terminal 2 via the communication path 7. The receiver 1311 receives the communication quality response A (first communication quality) for the dummy packet from the radio terminal 2 via the communication path 6. Then, the communication quality response A and the communication quality response B thus received are transmitted to the determination unit 1313.

Here, the communication quality response A and the communication quality response B have configurations as shown in FIG. 8(b). Specifically, the communication quality responses each includes the transmission time information included in the downlink packet and the dummy packet, and a time stamp indicating reception time representing a time at which the radio terminal 2 receives the downlink packet and the dummy packet (hereinafter referred to as reception time information).

The determination unit 1313 determines a second communication quality and a first communication quality from the communication quality response A and the communication response B received from the receiver 1311. As for the concrete method of specification, the difference between the transmission time information and the reception time information included in each of the communication quality response A and the communication quality response B is used as similar to the first embodiment and the description will therefore be omitted herein.

The path controller 1316 compares the first communication quality and the second communication quality determined by the determination unit 1313. The use of the communication path 7 as the communication path for the downlink communication is continued when the result of the comparison indicates that the first communication quality is equal to or below the second communication quality. On the other hand, the communication path used for the downlink communication is switched to the communication path 6 when the result of the comparison indicates that the first communication quality is higher than the second communication quality.

Moreover, when the communication path used for the downlink communication is switched to the communication path 6, the path controller 1316 does not release the communication path 7 but retains the communication path 7 so as to be usable for the downlink communication any time. The path controller 1316 switches the communication path used for the downlink communication to the communication path 7 again when a result of comparison between the first communication quality and the second communication quality after switching the communication path used for the downlink communication to the communication path 6 indicates that the first communication quality is higher than the second communication quality.

(1.2) Configuration of Radio Terminal

The detailed configuration of the radio terminal 2 according to the second embodiment, or namely, functional blocks of the radio communication unit 201 and the controller 203 will be described. FIG. 10 is a functional block diagram of the radio communication unit 201 and the controller 203 in the second embodiment.

As shown in FIG. 10, the radio communication unit 201 includes a receiver 1211 and a transmitter 1212. The controller 203 includes a determination unit 1213 and a time acquisition unit 1214.

The receiver 1211 receives the downlink packet from the access gateway 3 via the communication path 7. The receiver 1211 receives the dummy packet from the access gateway 3 via the communication path 6. The receiver 1211 transmits the downlink packet and the dummy packet to the generation unit 1213.

The generation unit 1213 generates the communication quality response A and the communication quality response B by use of the downlink packet and the dummy packet received from the receiver 1211. Specifically, the generation unit 1213 generates the communication quality response B by adding the reception time acquired from the time acquisition unit 1214 to the received downlink packet. Similarly, the generation unit 1213 generates the communication quality response A by adding the reception time acquired from the time acquisition unit 1214 to the received dummy packet.

The generation unit 1213 transmits the communication quality response A and the communication quality response B thus generated to the transmitter 1212. The transmitter 1212 transmits the communication quality response B to the access gateway 3 via the communication path 7. The time acquisition unit 1214 transmits the current time to the generation unit 1213 periodically.

(2) Operation of Radio Communication System

Now, (2.1) an overall operation of the radio communication system, and (2.2) a judgment operation for communication path switching in the access gateway will be described below in this order.

(2.1) Overall Operation of Radio Communication System

FIG. 11 is a sequence diagram showing an operation performed by the access gateway 3 for switching the communication path used for the downlink communication from the communication path 7 to the communication path 6. Note that this operation is started by at least any one of (a) to (c) indicated below as the trigger.

(a) The operation starts at every predetermined time interval.

(b) The operation starts when a radio quality (such as RSSI, SNR, or the like) of the radio communication path 7B is degraded.

(c) The operation starts when the number of bits per symbol is below a predetermined number in a modulation mode adapted to the radio quality of the radio communication path 7B.

In Step S1101, the radio terminal 2 and the access gateway are performing the uplink communication by using the communication path 6. Specifically, the transmitter 1212 of the radio terminal 2 is transmitting the uplink packet to the access gateway 3 via the radio base station 1A.

In Step S1102, the radio terminal 2 and the access gateway 3 are performing the downlink communication by using the communication path 7. Specifically, the transmitter 1312 of the access gateway 3 is transmitting the downlink packet to the radio terminal 2 via the radio base station 1B.

In Step S1103, the receiver 1311 of the access gateway 3 adds the transmission time information to the downlink packet and the dummy packet, which indicates the time point at which each of the packets is transmitted. In Step S1104, the transmitter 1312 of the access gateway 3 transmits the downlink packet to the radio terminal 2 via the communication path 7. In Step S1105, the transmitter 1312 of the access gateway 3 transmits the dummy packet to the radio terminal 2 via the communication path 6.

In Step S1106, the generation unit 1213 of the radio terminal 2 generates the communication quality response B by adding the reception time of the downlink packet. In Step S1107, the generation unit 1213 of the radio terminal 2 generates the communication quality response A by adding the reception time of the dummy packet.

In Step S1108, the transmitter 1212 of the radio terminal 2 transmits the generated communication quality response B to the access gateway 3 via the communication path 7 In Step S1109, the transmitter 1212 of the radio terminal 2 after the generation transmits the communication quality response A to the access gateway 3 via the communication path 6.

In Step S1110, the access gateway 3 judges whether or not to switch the communication path used for the downlink communication. The concrete judgment operation will be described in (2.2) a judgment operation for communication path switching in the access gateway. Here, the description will continue on the assumption that the first communication quality is higher than the second communication quality (YES in Step S1204 in FIG. 12).

In Step S1111, the radio terminal 2 and the access gateway 3 are performing the uplink communication by using the communication path 6. Specifically, the transmitter 1212 of the radio terminal 2 is transmitting the uplink packet to the access gateway 3 via the radio base station 1A.

In Step S1112, the radio terminal 2 and the access gateway 3 are performing the downlink communication by using the communication path 6. Specifically, the transmitter 1312 of the access gateway 3 is transmitting the downlink packet to the radio terminal 2 via the radio base station 1A. That is, the communications in two directions, namely, the uplink communication and the downlink communication, are carried out by using the communication path G. Accordingly, the radio base station 1A has functions as both RLSE and as FLSE.

(2.2) Judgment Operation for Communication Path Switching in Access Gateway

FIG. 12 is a flowchart showing an operation performed by the access gateway 3 to judge whether or not to switch the communication path used for the downlink communication.

In Step S1201, the receiver 1311 of the access gateway 3 receives the communication quality response A and the communication quality response B from the radio terminal 2. In Step S1202, the determination unit 1313 of the access gateway 3 determines the first communication quality by use of the difference between the transmission time and the reception time included in the communication quality response A. Specifically, in the second embodiment, the first communication quality is based on arrival time consumed from the transmission to the reception. For example, if the arrival time is long, it is likely that the quality of the communication path is degraded and the first communication quality is low. On the other hand, if the arrival time is short, it is likely that that the quality of the communication path is fine and the first communication quality is high.

In Step S1203, the determination unit 1313 of the access gateway 3 determines the second communication quality by use of the difference between the transmission time and the reception time included in the communication quality response B. Similarly to the first communication quality, the second communication quality is based on the arrival time consumed from the transmission to the reception.

In Step S1204, the determination unit 1313 of the access gateway 3 judges whether or not the first communication quality is higher than the second communication quality.

If the first communication quality is higher than the second communication quality (YES in Step S1204), the path controller 1316 of the access gateway 3 switches the communication path used for the downlink communication from the communication path 7 having the low communication quality to the communication path 6 having the high communication quality in Step S1205. Specifically, the path controller 1316 determines to stop the transmission of the downlink packet to the radio terminal 2 via the communication path 7 and determines to transmit the downlink packet to the radio terminal 2 via the communication path 6.

The wired communication path 6A and the wired communication path 7A are re-established in Step S1206. Specifically, the path controller 1316 of the access gateway 3 releases an IP tunnel (RL Only Binding) of the wired communication path 6A, then establishes an IP tunnel (RL+Primary Binding) with the radio base station 1A, and defines this IP tunnel as the wired communication path 6A. Meanwhile, since it is not possible to establish two IP tunnels (Primary Binding) at the same time, the path controller 1316 releases the IP tunnel (Primary Binding) of the wired communication path 7A, then establishes an IP tunnel (RL Only Binding) with the radio base station 1B, and defines this IP tunnel as the wired communication path 7A. This is because the wired communication path 6A being the wired section of the communication path 6 is the IP tunnel (RL Only Binding) and is therefore unable to transmit the downlink packet in accordance with the UMB specification.

In Step S1207, the transmitter 212 of the radio terminal 2 transmits the downlink packet to the access gateway 3 via the communication path 6. Specifically, the access gateway 3 transmits the forward packet to the radio terminal 2 via the communication path 6 having the higher communication quality than the communication path 7.

When the first communication quality is equal to or below the second communication quality (NO in Step S1204), the communication is continued without change. Specifically, the use of the communication path 7 having the high communication quality as the communication path used for the uplink communication is continued without switching to the communication path 6 having the low communication quality.

(3) Advantageous Effects

As described above, according to the second embodiment, the transmitter 1312 stops the transmission of the downlink packet via the communication path 7 and transmits the downlink packet to the radio terminal 2 via the communication path 6 when the first communication quality determined by the determination unit 1313 is higher than the second communication quality.

According to the above-described access gateway 3, when the communication quality of the communication path 7 in the downlink is degraded below the communication quality of the communication path 6 in the uplink, it is possible to stop the communication path 7 and to use the communication path 6 as the communication path used for the downlink communication. For this reason, even when the communication quality of the communication path used for the downlink communication is degraded, it is possible to perform the downlink communication favorably.

Furthermore, the determination unit 1313 determines the first communication quality based on the transmission time information and the reception time information included in the communication quality response A, and determines the second communication quality based on difference between the transmission time information and the reception time information included in the communication quality response B.

According to the above-described access gateway 3, it is possible to measure arrival time from the access gateway 3 to the radio terminal 2 on the communication path 7 (throughput of the communication path 7) by use of the downlink packet. Moreover, it is possible to measure arrival time from the access gateway 3 to the radio terminal 2 on the communication path 6 (throughput of the communication path 6) by use of the dummy packet.

For this reason, since the communication qualities of the communication path 6 and the communication path 7 can be determined based on the arrival time of the downlink packet and the dummy packet, it is possible to use one of the communication path 6 and the communication path 7 having the better throughput for the downlink communication. Specifically, even if the throughput of the communication path 7 is degraded by an increase in the traffic on the communication path 7, it is possible to switch the communication path for the downlink to the communication path 6 which is the known communication path. Hence it is possible to perform the downlink communication with a real-time performance.

Furthermore, the transmitter 1312 transmits the dummy packet to the radio terminal 2 when the radio quality between the radio terminal 2 and the radio base station 1B is lower than a predetermined value. Alternatively, the transmitter 1312 transmits the dummy packet to the radio terminal 2 when the number of bits per symbol is below a predetermined number in the modulation mode adapted to the radio quality between the radio terminal 2 and the radio base station 1B.

Specifically, the transmitter 1312 does not transmit the dummy packet to the radio terminal 2 when the radio quality between the radio terminal 2 and the radio base station 1B is equal to or above the predetermined value. The transmitter 1312 does not transmit the dummy packet to the radio terminal 2 when the number of bits per symbol is equal to or above the predetermined number in the modulation mode adapted to the radio quality between the radio terminal 2 and the radio base station 1B.

That is, the judgment operation for communication path switching is started only when the radio quality of the radio section is deteriorated. Accordingly, it is possible reduce a frequency of transmission of the dummy packet.

The communication path 6 (the radio communication path 6B and the IP tunnel (RL Only Binding)) is the communication path which is not usable for transmission of the downlink packet but is usable for transmission of the dummy packet, and cannot be established simultaneously with the communication path 6 (the radio communication path 6B and the IP tunnel (RL+Primary Binding)). When establishing the communication path 6 (the radio communication path 6B and the IP tunnel (RL+Primary Binding)), the path controller 1316 releases the establishment of the communication path 6 (the radio communication path 6B and the IP tunnel (RL Only Binding)) 6.

Therefore, even when the communication path 6 (the radio communication path 68 and the IP tunnel (RL Only Binding)) that passes through the radio base station 1A is not usable, the communication path 6 (the radio communication path 6B and the IP tunnel (RL+Primary Binding)) that passes through the radio base station 1A is established and thus, the communication path that is suitable for the downlink communication can be used for the downlink communication. Hence it is possible to perform the downlink communication favorably.

### Modification of Second Embodiment

In the above-described second embodiment, the determination unit 1313 determines the first communication quality and the second communication quality based on the difference between the transmission time period information and the reception time period information included in the communication quality response A and the communication quality response B.

In a modification of the second embodiment, the determination unit 1313 determines the first communication quality and the second communication quality by using at least one of methods using (1) average arrival time, (2) reception time interval, and (3) reception time interval and data amount.

(1) Average Arrival Time

The transmitter 1312 of the access gateway 3 prepares multiple sets of the downlink packets and the dummy packets for determining the communication qualities of the communication path 6 and the communication path 7, For example, N pieces of the downlink packets and N pieces of the dummy packets are prepared and defined as the downlink packet 1 to the downlink packet N and as the dummy packet 1 to the dummy packet N. The transmitter 1312 of the access gateway 3 adds the transmission time information to each of the multiple downlink packets (the downlink packet 1 to the downlink packet N) and the multiple dummy packets (the dummy packet 1 to the dummy packet N). Then, the transmitter 1312 of the access gateway 3 transmits the multiple downlink packets to the access gateway 3 via the communication path 7. The transmitter 1312 of the access gateway 3 transmits the multiple dummy packets to the access gateway 3 via the communication path 6.

The generation unit 1213 of the radio terminal 2 generates the multiple communication quality responses B (the communication quality response B1 to the communication quality response BN) by adding the reception times of the multiple downlink packets. The generation unit 1213 of the radio terminal 2 generates the multiple communication quality responses A (the communication quality response Al to the communication quality response AN) by adding the reception times of the multiple dummy packets.

The transmitter 1212 of the radio terminal 2 transmits the multiple communication quality responses B thus generated to the access gateway 3 via the communication path 7. The transmitter 1212 of the radio terminal 2 transmits the multiple communication quality responses A to the access gateway 3 via the communication path 6.

The receiver 1311 of the access gateway 3 receives the multiple communication quality responses A and the multiple communication quality responses B from the radio terminal 2. The determination unit 1313 of the access gateway 3 obtains the difference between the transmission time and the reception time included in each of the multiple communication quality responses A, and obtains a first average difference which is an average value of the multiple differences thus obtained. Thereafter, the determination unit 1313 of the access gateway 3 determines the first communication quality by use of the first average difference.

Similarly, the determination unit 1313 of the access gateway 3 obtains the difference between the transmission time and the reception time included in each of the multiple communication quality responses B, and obtains a second average difference which is an average value of the multiple differences thus obtained. Thereafter, the determination unit 1313 of the access gateway 3 determines the second communication quality by use of the second average difference.

Alternatively, it is also possible to obtain the difference between the transmission time and the reception time only for any number of responses among the multiple communication quality responses A and the multiple communication quality responses B, and to determine the first communication quality and the second communication quality by use of average values of the differences obtained for the any number of responses.

(2) Reception Time Interval

The transmitter 1312 of the access gateway 3 prepares multiple sets of the downlink packets and the dummy packets for determining the communication qualities of the communication path 6 and the communication path 7. For example, N pieces of the downlink packets and N pieces of the dummy packets are prepared and defined as the downlink packet 1 to the downlink packet N and as the dummy packet 1 to the dummy packet N. Then, the transmitter 1312 of the access gateway 3 transmits the multiple uplink packets to the radio terminal 2 via the communication path 7. The transmitter 1312 of the access gateway 3 transmits the multiple dummy packets to the access gateway 3 via the communication path 6.

The generation unit 1213 of the radio terminal 2 generates the communication quality response B which includes initial reception time being the reception time of the downlink packet initially received among the multiple downlink packets and final reception time being the reception time of the downlink packet finally received among the multiple downlink packets. The generation unit 1213 of the radio terminal 2 generates the communication quality response A which includes initial reception time being the reception time of the dummy packet initially received among the multiple dummy packets and final reception time being the reception time of the dummy packet finally received among the multiple dummy packets.

The transmitter 1212 of the radio terminal 2 transmits the communication quality response B thus generated to the radio terminal 2 via the communication path 7. The transmitter 1212 of the radio terminal 2 transmits the communication quality response A to the radio terminal 2 via the communication path 6.

The receiver 1311 of the access gateway 3 receives the communication quality response A and the communication quality response B from the radio terminal 2. The determination unit 1313 of the access gateway 3 determines the first communication quality from the difference between initial reception time and the final reception time included in the communication quality response A. The determination unit 1313 of the access gateway 3 determines the second communication quality from the difference between initial reception time and the final reception time included in the communication quality response B.

(3) Reception Time Interval and Data Amount

In the case of (2), the determination unit 1313 of the access gateway 3 determines the second communication quality based on a data size which is a sum of data amounts of the multiple downlink packets transmitted from the transmitter 1312 of the access gateway 3, and on a difference between initial reception time information and final reception time information included in the communication quality response B.

Similarly, the determination unit 1313 of the access gateway 3 determines the first communication quality based on a data size which is a sum of data amounts of the multiple dummy packets transmitted from the transmitter 1312 of the access gateway 3, and on a difference between initial reception time information and final reception time information included in the communication quality response A.

(4) Advantageous Effects of Modification of Second Embodiment

As described above, the communication quality can be more accurately determined by determining the communication quality of the communication path by use of the multiple pieces of data. Therefore, the communication path having the fine communication quality can be used accurately for the downlink communication and the downlink communication can be favorably performed.

### Other Embodiments

As described above, the present invention has been described by using the first embodiment and the second embodiment. However, it should not be understood that the description and drawings which constitute part of this disclosure limit the present invention. From this disclosure, various alternative embodiments, examples, and operation techniques will be easily found by those skilled in the art.

The above-described embodiments have explained the communications between the radio terminal 2 and the access gateway 3. However, instead of the access gateway 3, it is possible to use an anchor base station (DAP) configured to receive data addressed to the access gateway 3 from the radio terminal 2 via the radio base station 1A in the uplink communication and to receive data addressed to the radio terminal 2 from the backhaul network 4 not through another radio base station in the downlink communication. Instead of the access gateway 3, it is possible to use a relay device which is connected to a periphery of the access gateway 3 or the DAP and is able to capture communication data between either the access gateway 3 or the DAP and the radio terminal 2.

In addition, in the embodiments described above, although a configuration based on the UMB system is described, the present invention is not limited to the UMB system and can be applied to any radio communication system, as long as different radio base stations can serve as an uplink radio communication partner and a downlink radio communication partner.

For example, the present invention may be applied to LTE-Advanced which is positioned as the fourth generation (4G) mobile phone system. In a next-generation radio communication system such as LTE-Advanced or the like, specification may be such that a radio terminal can connect to different radio base stations in the reverse and the downlinks. In such a specification, it is contemplated that different base stations can serve as the downlink radio communication partner (FLSE) and the uplink radio communication partner (RLSE), as appropriate, not only during a handover. Application of the present invention allows the uplink/downlink communication to be favorably performed, even in the next-generation radio communication system such as LTE-Advanced. In LTE, the access gateway 3 is referred to as a serving gateway, a PDN gateway, or the like

Moreover, the first embodiment and the second embodiment may be carried out either separately or at the same time.

As described above, it should be understood that the present invention includes various embodiments which are not described herein. Accordingly, the present invention should be limited only by the scope of claims regarded as appropriate based on the description.

Note that the entire contents of Japanese Patent Application No. 2008-331608 (filed on Dec. 25, 2008) and Japanese Patent Application No. 2008-331609 (filed on Dec. 25, 2008) are incorporated herein by reference.

### INDUSTRIAL APPLICABILITY

As described above, the radio terminal, the relay device, and the radio communication method according to the present invention allow uplink/downlink communication to be performed favorably even when communication quality of a communication path used for the uplink/downlink communication is degraded in a radio communication system in which different radio base stations can serve as a radio base station that performs radio communication with a radio terminal in an uplink and a radio base station that performs radio communication with the radio terminal in a downlink. Hence the present invention is useful for a radio communication such as a mobile communication.

1. A radio terminal configured to establish a first communication path via a first radio base station provided on a communication network and a second communication path via a second radio base station provided on the communication network to a relay device provided on the communication network, the radio terminal comprising:
a transmitter configured to transmit uplink data to the relay device via the first communication path;
a receiver configured to receive downlink data from the relay device via the second communication path; and
a determination unit configured to determine a first communication quality of the first communication path in an uplink and a second communication quality of the second communication path in the uplink, wherein
the transmitter transmits predetermined data to be used to determine the second communication quality to the relay device via the second communication path,
the determination unit determines the first communication quality by using the uplink data and determines the second communication quality by using the predetermined data, and
the transmitter stops transmission of the uplink data via the first communication path and transmits the uplink data to the relay device via the second communication path when the second communication quality determined by the determination unit is higher than the first communication quality.

2. The radio terminal according to claim 1, wherein
the transmitter transmits the uplink data with first transmission time information included therein to the relay device, the first transmission time information indicating a time at which the uplink data is transmitted,
the receiver receives a first communication quality response including the first transmission time information and first reception time information indicating a time at which the uplink data is received by the relay device,
the determination unit determines the first communication quality based on a difference between the first transmission time information and the first reception time information included in the first communication quality response,
the transmitter transmits the predetermined data with second transmission time information included therein to the relay device, the second transmission time information indicating a time at which the predetermined data is transmitted,
the receiver receives a second communication quality response including the second transmission time information and second reception time information indicating a time at which the predetermined data is received by the relay device, and
the determination unit determines the second communication quality based on a difference between the second transmission time information and the second reception time information included in the second communication quality response.

3. The radio terminal according to claim 2, wherein
the transmitter transmits the uplink data in plurality and the predetermined data in plurality to the relay device,
the receiver receives a plurality of first communication quality responses to the uplink data transmitted in plurality and a plurality of first communication quality responses to the predetermined data transmitted in plurality,
the determination unit determines the first communication quality based on an average of differences between the first transmission time information and the first reception time information included in the plurality of first communication quality responses received by the receiver, and
the determination unit determines the second communication quality based on an average of differences between the second transmission time information and the second reception time information included in the plurality of second communication quality responses received by the receiver.

4. The radio terminal according to claim 1, wherein
the transmitter transmits the uplink data in plurality and the predetermined data in plurality to the relay device,
the receiver receives
a first communication quality response including first initial reception time information indicating a reception time of the uplink data initially received by the relay device and first final reception time information indicating a reception time of the uplink data finally received by the relay device among the uplink data transmitted in plurality, and
a second communication quality response including second initial reception time information indicating a reception time of the predetermined data initially received by the relay device and second final reception time information indicating a reception time of the predetermined data finally received by the relay device among the predetermined data transmitted in plurality, and
the determination unit determines
the first communication quality based on a difference between the first initial reception time information and the first final reception time information included in the first communication quality response, and
the second communication quality based on a difference between the second initial reception time information and the second final reception time information included in the second communication quality response.

5. The radio terminal according to claim 4, wherein
the determination unit determines
the first communication quality based on a total data amount of the uplink data transmitted in plurality by the transmitter and on the difference between the first initial reception time information and the first final reception time information included in the first communication quality response, and
the second communication quality based on a total data amount of the predetermined data transmitted in plurality by the transmitter and on the difference between the second initial reception time information and the second final reception time information included in the second communication quality response.

6. The radio terminal according to claim 1, wherein the transmitter transmits the predetermined data to the relay device when a radio quality between the radio terminal and the first radio base station is lower than a predetermined value.

7. The radio terminal according to claim 6, wherein the transmitter transmits the predetermined data to the relay device when the number of bits per symbol is below a predetermined number in a modulation mode adapted to the radio quality.

8. A radio communication method in a radio terminal configured to establish a first communication path via a first radio base station provided on a communication network and a second communication path via a second radio base station provided on the communication network to a relay device provided on the communication network, the radio communication method comprising the steps of:
transmitting uplink data to the relay device via the first communication path;
receiving downlink data from the relay device via the second communication path;
transmitting predetermined data to be used to determine a second communication quality of the second communication path in an uplink to the relay device via the second communication path;
determining a first communication quality of the first communication path in the uplink by using the uplink data;
determining the second communication quality by using the predetermined data; and
stopping transmission of the uplink data via the first communication path and transmitting the uplink data to the relay device via the second communication path when the determined second communication quality is higher than the first communication quality.

9. A relay device provided on a communication network and configured to establish a first communication path via a first radio base station provided on the communication network and a second communication path via a second radio base station provided on the communication network to a radio terminal, the relay device comprising:
a receiver configured to receive uplink data from the radio terminal via the first communication path;
a transmitter configured to transmit downlink data to the radio terminal via the second communication path; and
a determination unit configured to determine a first communication quality of the first communication path in a downlink and a second communication quality of the second communication path in the downlink, wherein
the transmitter transmits predetermined data to be used to determine the first communication quality to the radio terminal via the first communication path,
the determination unit determines the second communication quality by using the downlink data and determines the first communication quality by using the predetermined data, and
the transmitter stops transmission of the downlink data via the second communication path and transmits the downlink data to the radio terminal via the first communication path when the first communication quality determined by the determination unit is higher than the second communication quality.

10. The relay device according to claim 9, wherein
the transmitter transmits the predetermined data with first transmission time information included therein to predetermined data, the first transmission time information indicating a time at which the predetermined data is transmitted
the receiver receives a first communication quality response including the first transmission time information and first reception time information indicating a time at which the predetermined data is received by the radio terminal,
the determination unit determines the first communication quality based on a difference between the first transmission time information and the first reception time information included in the first communication quality response,
the transmitter transmits the downlink data with second transmission time information included therein to the radio terminal, the second transmission time information indicating a time at which the downlink data is transmitted,
the receiver receives a second communication quality response including the second transmission time information and second reception time information indicating a time at which the downlink data is received by the radio terminal, and
the determination unit determines the second communication quality based on a difference between the first transmission time information and the first reception time information included in the second communication quality response.

11. The relay device according to claim 10,
wherein the transmitter transmits the predetermined data in plurality and the downlink data in plurality to the radio terminal,
the receiver receives a plurality of first communication quality responses to the predetermined data transmitted in plurality and a plurality of second communication quality responses to the downlink data transmitted in plurality,
the determination unit determines the first communication quality based on an average of differences between the first transmission time information and the first reception time information included in the plurality of first communication quality responses received by the receiver, and
the determination unit determines the second communication quality based on an average of differences between the second transmission time information and the second reception time information included in the plurality of second communication quality responses received by the receiver.

12. The relay device according to claim 9, wherein
the transmitter transmits the predetermined data in plurality and the downlink data in plurality to the radio terminal,
the receiver receives
a first communication quality response including first initial reception time information indicating a reception time of the predetermined data initially received by the radio terminal and first final reception time information indicating a reception time of the predetermined data finally received by the radio terminal among the predetermined data transmitted in plurality, and
a second communication quality response including second initial reception time information indicating a reception time of the downlink data initially received by the radio terminal and second final reception time information indicating a reception time of the downlink data finally received by the radio terminal among the downlink data transmitted in plurality, and
the determination unit determines
the first communication quality based on a difference between the first initial reception time information and the first final reception time information included in the first communication quality response, and
the second communication quality based on a difference between the second initial reception time information and the second final reception time information included in the second communication quality response.

13. The relay device according to claim 12, wherein
the determination unit determines the first communication quality based on a total data amount of the predetermined data transmitted in plurality by the transmitter and on the difference between the first initial reception time information and the first final reception time information included in the first communication quality response, and
the determination unit determines the second communication quality based on a total data amount of the downlink data transmitted in plurality by the transmitter and on the difference between the second initial reception time information and the second final reception time information included in the second communication quality response.

14. The relay device according to claim 9, wherein the transmitter transmits the predetermined data to the radio terminal when a radio quality between the radio terminal and the second radio base station is lower than a predetermined value.

15. The relay device according to claim 14, wherein the transmitter transmits the predetermined data to the radio terminal when the number of bits per symbol is below a predetermined number in a modulation mode adapted to the radio quality.

16. The relay device according to claim 9, further comprising:
a path controller configured to establish a third communication path via the first radio base station to the radio terminal when the first communication quality determined by the determination unit is higher than the second communication quality, wherein
the transmitter transmits the downlink data by using the third communication path instead of the first communication path when the third communication path is established,
the first communication path is a communication path which is unusable for transmission of the downlink data, usable for transmission of the predetermined data, and unable to be established simultaneously with the third communication path, and
the path controller releases establishment of the first communication path when establishing the third communication path.

17. A radio communication method in a relay device provided on a communication network and configured to establish a first communication path via a first radio base station provided on the communication network and a second communication path via a second radio base station provided on the communication network to a radio terminal, the radio communication method comprising the steps of:
receiving predetermined data from the radio terminal via the first communication path;
transmitting downlink data to the radio terminal via the second communication path;
transmitting predetermined data to be used to determine a first communication quality of the first communication path in a downlink to the radio terminal via the first communication path;
determining a second communication quality of the second communication path in the downlink by using the downlink data;
determining the first communication quality by using the predetermined data; and
stopping transmission of the downlink data via the second communication path and transmitting the downlink data to the radio terminal via the first communication path when the determined first communication quality is higher than the second communication quality.
